(19) United States
(12) Patent Application Publication
(10) Pub. No.: US 2019/0146469 A1
(43) Pub. Date: May 16, 2019

(54) SYSTEM AND METHOD FOR FACILITATING COMPREHENSIVE CONTROL DATA FOR A DEVICE

(71) Applicant: Palo Alto Research Center Incorporated, Palo Alto, CA (US)

(72) Inventors: Ion Matei, Sunnyvale, CA (US); Rajinderjeet S. Minhas, Palo Alto, CA (US); Johan de Kleer, Los Altos, CA (US); Anurag Ganguli, Milpitas, CA (US)

(73) Assignee: Palo Alto Research Center Incorporated, Palo Alto, CA (US)

(21) Appl. No.: 15/815,528

(22) Filed: Nov. 16, 2017

(51) Int. Cl. G05B 23/02; G06F 15/18; G05B 17/02; G06F 11/30; G06F 17/50

(52) U.S. Cl. CPC G05B 23/0208; G06F 15/18; G06F 17/5027; G06F 11/3003; G05B 17/02

(57) ABSTRACT

Embodiments described herein provide a system for facilitating comprehensive control data for a device. During operation, the system determines one or more properties of the device that can be applied to empirical data of the device. The empirical data can be obtained based on experiments performed on the device. The system applies the one or more properties to the empirical data to obtain derived data and learns an efficient policy for the device based on both empirical and derived data. The efficient policy indicates one or more operations of the device that can reach a target state from an initial state of the device. The system then determines an operation for the device based on the efficient policy.

### BACKGROUND

### Field

This disclosure is generally related to control data management for a system. More specifically, this disclosure is related to a method and system for augmenting an insufficient data set by using geometric properties of the system to generate comprehensive control data that indicates the behavior of the device.

### Related Art

With the advancement of computer and network technologies, various operations performed by users of different applications have led to extensive use of data processing. Such data processing techniques have been extended to the analysis of a large amount of empirical data associated with a device to determine behaviors of the device. This proliferation of data continues to create a vast amount of digital content. In addition, scientific explorations continue to demand more data processing in a short amount of time. This rise of big data has brought many challenges and opportunities. Recent heterogeneous high performance computing architectures offer viable platforms for addressing the computational challenges of mining and learning with device data. As a result, device data processing is becoming increasingly important with applications in machine learning and use of machine learning for device operations.

Learning models of the device or learning policies for optimizing an operation of the device relies on potentially large training data sets that describe the behavior of the device. When such training data sets are incomplete or unavailable, an alternative is to supplement the training data set. Such alternatives may include generating simulation data, if an analytical model of the device is available, or executing experiments on the device.

However, both alternatives bring their respective challenges. To build a model representing the physical behavior of the device (e.g., a physics-based model), information about the physical processes that govern the behavior of the device is needed. In addition, such a model needs a set of parameters that control such physical processes. Unfortunately, usually such parameters are not easily accessible. For example, often the components of a device originate from different manufacturers, who may not share technical proprietary information about their products. On the other hand, generating empirical data by experimenting with the device in real life scenarios may also not be feasible since all possible operations may not be determined from a deployed device, or due to high cost.

While analyzing device data, which can include experimental or empirical data, brings many desirable features to device control operations, some issues remain unsolved in efficiently generating and analyzing extensive control data for the device for determining comprehensive device operations.

### SUMMARY

Embodiments described herein provide a system for facilitating control policies for a device. During operation, the system determines one or more properties, such as geometric properties, of the device that can be applied to empirical data of the device. The empirical data can be obtained based on experiments performed on the device. The system applies the one or more properties to the empirical data to obtain derived data and learns an efficient policy for the device based on both empirical and derived data. The efficient policy indicates one or more operations of the device that can reach a target state from an initial state of the device. The system then determines an operation for the device based on the efficient policy.

In a variation on this embodiment, the system applies the one or more properties to the empirical data by determining a first state and a corresponding first operation from the empirical data and deriving a second state and a corresponding second operation by calculating the one or more properties for the first state and the first operation.

In a variation on this embodiment, the system learns the efficient policy for the device by determining a first state transition in the derived data that maximizes a corresponding first reward function based on a second state transition in the empirical data that maximizes a corresponding second reward function. The first and second reward functions indicate a benefit of the first and second state transitions for the device, respectively

In a further variation, the system also learns the efficient policy for the device by updating a learning function for the first and second state transitions.

In a further variation, the system updates the learning function for the first state transition by computing the learning function based on a relationship between the first and second reward functions.

In a variation on this embodiment, the one or more properties include a symmetry of operations of the device.

In a variation on this embodiment, the system determines the operation for the device by determining a current environment for the device, identifying a state representing the current environment, and determining the operation corresponding to the state based on the efficient policy.

In a variation on this embodiment, the system obtains a set of trajectories for the device. A respective trajectory indicates a sequence of state transitions for the device. The system then determines the efficient policy based on the entire set of trajectories.

### BRIEF DESCRIPTION OF THE FIGURES

FIG. 1A illustrates an exemplary control prediction system, in accordance with an embodiment described herein.

FIG. 1B illustrates an exemplary control prediction system operating in conjunction with an exemplary control system based on reinforcement learning, in accordance with an embodiment described herein.

FIG. 1C illustrates an exemplary reinforcement learning of a control prediction system, in accordance with an embodiment described herein.

FIG. 2A presents a flowchart illustrating a method of a control system obtaining a control data set for a device and determining corresponding device behavior, in accordance with an embodiment described herein.

FIG. 2B presents a flowchart illustrating a method of a control prediction system determining a control data set for a device, in accordance with an embodiment described herein.

FIG. 3 presents a flowchart illustrating a method of a control system determining an efficient policy for a device, in accordance with an embodiment described herein.

FIG. 4A presents a flowchart illustrating a method of a control system learning an efficient policy based on learning data, in accordance with an embodiment described herein.

FIG. 4B presents a flowchart illustrating a method of a control system updating empirical learning data for learning an efficient policy, in accordance with an embodiment described herein.

FIG. 4C presents a flowchart illustrating a method of a control system updating derived learning data for learning an efficient policy, in accordance with an embodiment described herein.

FIG. 5 presents a flowchart illustrating a method of a control system determining a control operation the environment of a device, in accordance with an embodiment described herein.

FIG. 6 illustrates an exemplary computer and communication system that facilitates a control and prediction system, in accordance with an embodiment described herein.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

Embodiments described herein solve the problem of efficiently determining control data for a device when a behavioral model for the device is not available or performing experiments is not feasible by augmenting insufficient control data using properties of the device (e.g., geometric properties).

Learning a model or learning a policy that optimizes the operations (or actions) of a device (e.g., for automation) can rely on data sets that describe the behavior of the device. With existing technologies, when such a data set is not available or includes insufficient information, additional data can be generated through simulations or experiments. To run a simulation, an accurate and extensive model should be available for the device. However, a model may be incomplete and hence, cannot describe all operations that the device may perform. On the other hand, sometimes performing experiments is not feasible.

To solve this problem, embodiments described herein provide a control prediction system that can generate control data for a device based on empirical data of the device. For example, the system can obtain empirical data (e.g., experimental data) from a control system of the device. The control system can be responsible for controlling the device (e.g., for automation). The control system can reside in the device or can be co-located with the control prediction system. The control prediction system then analyzes the empirical data to determine whether any property of the device can be applied to the empirical data to derive new data. For example, the system can use geometric properties, such as symmetry, to generate new derived data. The derived data can augment the empirical data to generate more comprehensive control data for the device.

The control prediction system can provide the control data to the control system. The control system can use the control data to determine an operation for the device based on an environment of the device. The control system can determine what operation is likely to direct the device toward a goal. For example, if the device is a vehicle and the goal is to turn the vehicle, the control system can determine what operations should be performed to the vehicle to make the turn based on the control data (e.g., how much the wheels should turn).

In some embodiments, the control system can use a learning algorithm to learn an efficient policy for a goal for the device through one or more states. For example, if the device is at an initial state (e.g., a vehicle in a parked state) and the goal is to reach a destination, the system applies a learning algorithm (e.g., a Q-learning algorithm) to determine the transition between two states that generates a desirable reward for reaching the goal. Unlike a traditional learning algorithm, the system can use both empirical data and derived data to determine the efficient policy for the device. As a result, the learning process of the control system becomes comprehensive, leading to accurate decision making.

Although the instant disclosure is presented using examples based on learning-based data mining on empirical and derived data, embodiments described herein are not limited to learning-based computations or a type of a data set. Embodiments described herein can also be applied to any learning-based data analysis. In this disclosure, the term “learning” is used in a generic sense, and can refer to any inference techniques derived from feature extraction from a data set.

The term “message” refers to a group of bits that can be transported together across a network. “Message” should not be interpreted as limiting embodiments of the present invention to any networking layer. “Message” can be replaced by other terminologies referring to a group of bits, such as “packet,” “frame,” “cell,” or “datagram.”

### Control Prediction System

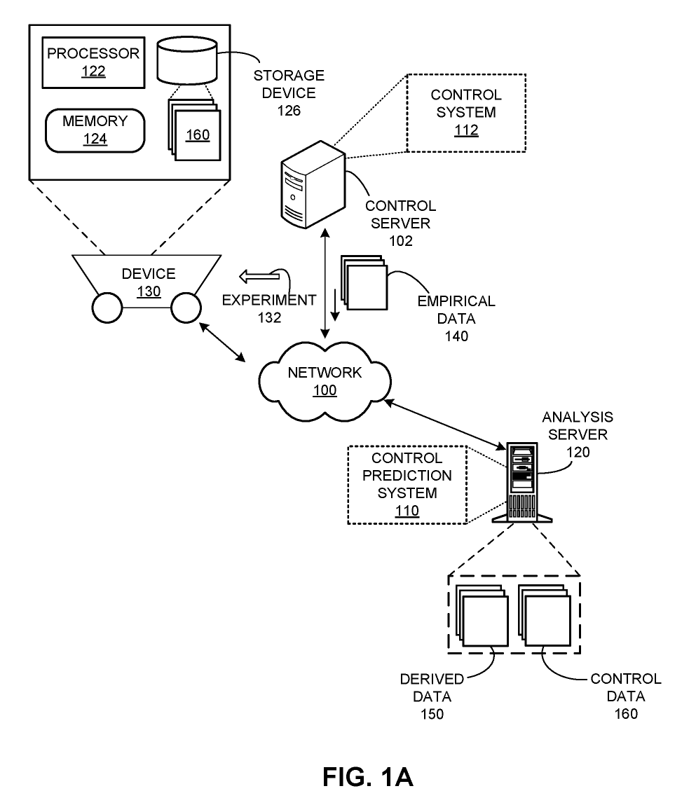

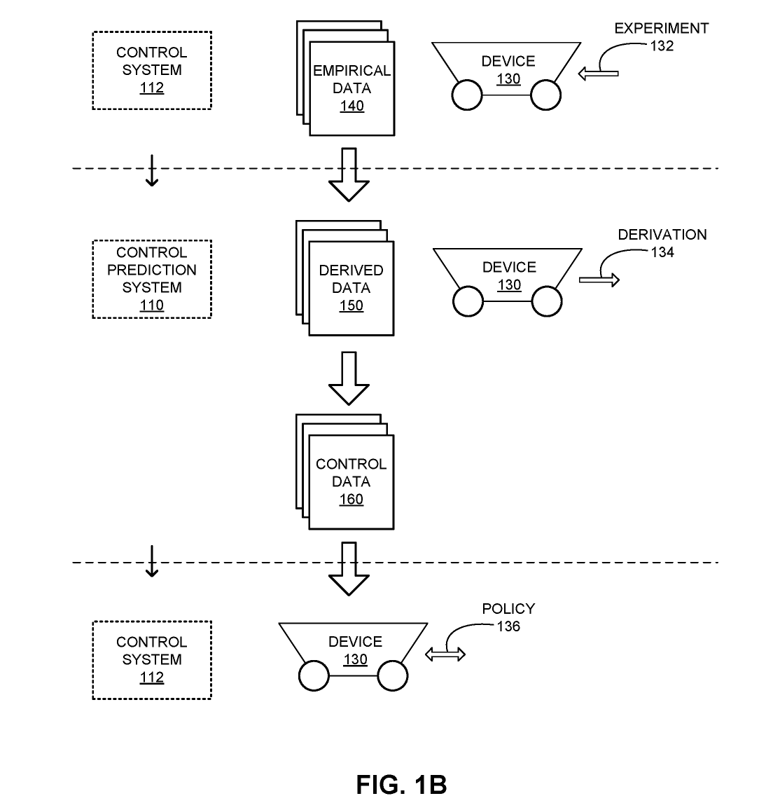

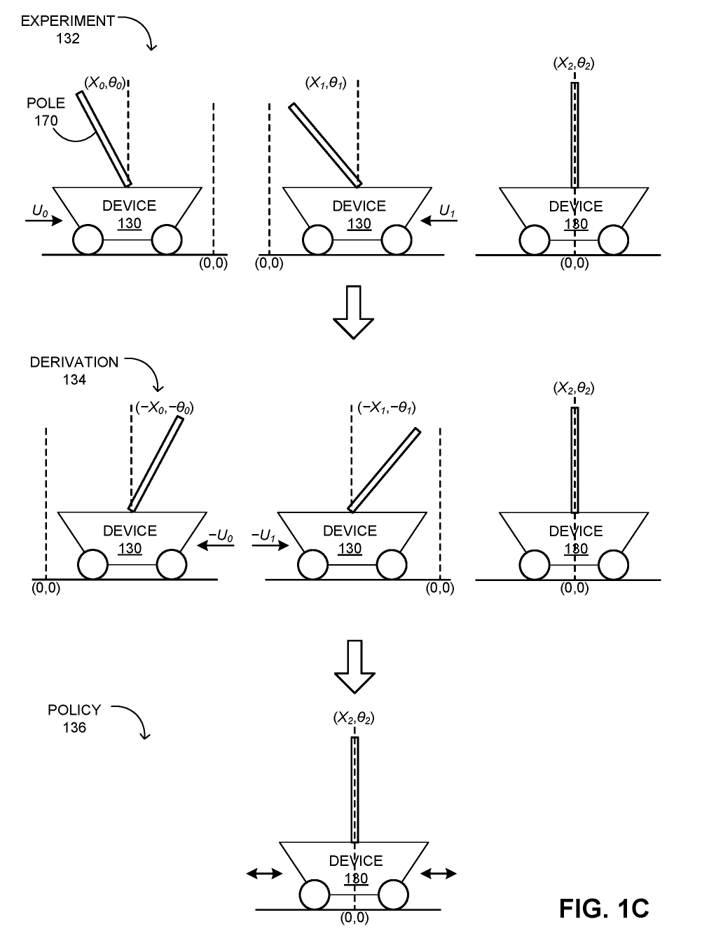

FIG. 1A illustrates an exemplary control prediction system, in accordance with an embodiment described herein. In this example, a device 130 can be any electric or mechanical device that can be controlled based on instructions issued from a control system 112. In this example, control system 112 operates on a control server 102 and communicates with device 130 via a network 100. Each of device 130 and control server 102 can be equipped with one or more communication devices, such as interface cards capable of communicating via a wired or wireless connection. Examples of an interface card include, but are not limited to, an Ethernet card, a wireless local area network (WLAN) interface (e.g., based on The Institute of Electrical and Electronics Engineers (IEEE) 802.11), and a cellular interface. Control system 112 can also operate on device 130.

For example, device 130 can also be equipped with a memory 124 that stores instructions that when executed by a processor 122 of device 130 cause processor 122 to perform instructions for operating device 130. These instructions can allow automation of device 130. Control system 112 can learn a policy that optimizes the operations of device 130. To do so, control system 112 relies on data sets that describe the behavior of device 130. Such data should be reliable and comprehensive, so that control system 112 can issue instructions to device 130 in way that allows control system 112 to control device 130 to reach a goal in an efficient way.

With existing technologies, such a data set can be generated through simulations or experiments. To run a simulation, an accurate and extensive model should be available for device 130. However, real-life behavior of device 130 may not fit any model. In addition, a model may not describe all operations that device 130 may perform. On the other hand, sometimes performing extensive experiments on device 130 may not be feasible. Furthermore, experimenting on device 130 to determine all possible behavior of device 130 may become burdensome and expensive.

To solve this problem, embodiments described herein provide a control prediction system 110 that can generate control data for device 130 based on empirical data of device 130. Empirical data of device 130 can also be referred to as experience. During operation, an experiment 132 can be performed on device 130 based on an instruction from control system 112. This instruction can be generated by control system 112 or provided by an operator of device 130. Control system 112 obtains empirical data 140 generated from experiment 132. For example, if device 130 is a quad-copter, experiment 132 can include the forward movement of device 130. The corresponding empirical data 140 can include the rotation of each of the rotators of device 130 and the corresponding velocity of device 130.

Control prediction system 110 can obtain empirical data 140 from control system 112. Control prediction system 110 can operate on an analysis server 120, which can be coupled to control server 102 via network 100. It should be noted that analysis server 120 and control server 102 can be the same physical machine. Furthermore, control prediction system 110 can run on device 130 as well. Control prediction system 110 analyzes empirical data 140 to determine whether any property of device 130 can be applied to empirical data 140 to derive new data. For example, control prediction system 110 can use geometric properties, such as symmetry, of device 130 to generate new derived data 150 from empirical data 140. Derived data 150 can augment empirical data 140 to generate more comprehensive control data 160 for device 130.

Control prediction system 110 can provide control data 160 to control system 112. Control system 112 can use control data 160 to determine an operation for device 130 based on an environment of device 130. If control system 112 operates on device 130, control system 112 can store control data 160 in a storage device 126 of device 130. Control system 112 can determine what operation is likely to direct device 130 toward a goal. For example, if device 130 is a vehicle and the goal is to turn device 130, control system 112 can determine what operations should be performed to device 130 to make the turn based on control data 160 (e.g., how much the wheels should turn).

In some embodiments, control system 112 can use a learning algorithm to learn an efficient policy for a goal for device 130. To reach the goal, device 130 can transition through one or more states. For example, if device 130 is at an initial state (e.g., a vehicle in a parked state) and the goal is to reach a destination, control system 112 applies a learning algorithm to control data 160 to determine the transition between respective state pairs that generates the desirable reward (e.g., the shortest distance or fastest route) for reaching the goal. Unlike a traditional learning algorithm, control system 112 can use both empirical data 140 and derived data 150 to determine the efficient policy for device 130. As a result, the learning process of control system 112 becomes comprehensive, leading to accurate decision making.

### Reinforcement Learning

Reinforcement learning refers to finding a correspondence between the behavior of device 130 and possible operations of device 130 to maximize a reward function of device 130. This reward function can indicate the reward for transitioning between two states of device 130. A specific sequence of state transitions can indicate a trajectory of operations (or a trajectory in short) for device 130. The learning is performed through discovery of operations that improve the reward function. In some embodiments, the reinforcement learning technique used by control system 112 obtains the correspondence by iterating the operations along different trajectory samples.

Typically, learning the efficient policy depends on the richness of control data 160, which describes the response of device 130 as a result of actions applied to it. To ensure richness, control system 112 includes both derived data 150 as well as empirical data 140 in control data 160. To do so, the iterations are performed over the trajectories in both empirical data 140 and derived data 150. This approach achieves higher coverage of the operation space and improved convergence rates.

FIG. 1B illustrates an exemplary control prediction system operating in conjunction with an exemplary control system based on reinforcement learning, in accordance with an embodiment described herein. In this example, an experiment 132 performed on device 130 generates empirical data 140. Control system 112 provides this empirical data 140 to control prediction system 110, which applies one or more properties of device 130 to empirical data 140 to generate a derivation 134. For example, if experiment 132 indicates how device 130 travels from right to left, the symmetry property of device 130 allows control prediction system 110 to determine derivation 134 that indicates how device 130 travels from left to right.

Control prediction system 110 then combines derived data 150 and empirical data 140 to generate control data 160 and provides control data 160 to control system 112. Control system 112 then applies reinforcement learning to control data 160 to determine an efficient policy 136 of how to control device 130 along trajectories in both empirical data 140 and derived data 150. For example, policy 136 can indicate how device 130 can efficiently travel from right to left and from left to right.

In some embodiments, policy 136 defines the probability distribution of the operations for each state of device 130. Policy 136 can be stationary if it does not explicitly depend on time, and deterministic when each operation has the probability of 1. For deterministic and stationary scenarios, if the efficient operation can be determined for each state, the corresponding efficient policy can be determined. To achieve such a scenario, the corresponding control data should be comprehensive. Based on control data 160, control system 112 can obtain an approximation of the learning process.

In some embodiments, reinforcement learning includes a Q-function, which indicates what control system 112 has learned in each iteration. Obtaining an accurate approximation for the Q-function depends on the size of the training data, which is dictated by the available empirical data (explored sample trajectories) as well as the derived data. This allows control system 112 to explore derived actions for states that result from the properties of device 130.

Suppose that a sample trajectory associated with empirical data 140 corresponds to policy 136. Control system 112 can iteratively learn the Q-function for an operation u₁ at a state x₁ in the sample trajectory. Control system 112 can also determine another operation u₂ and another state x₂ derived from the operation and state pair (u₁, x₁) based on one or more properties of device 130. This other operation and state pair (u₂, x₂) can be in the derived data 150. Since the symmetry property indicates that (u₂, x₂) represents a feasible trajectory for device 130, control system 112 can add a new iteration to simultaneously determine the Q-function for both pairs. In some embodiments, if the corresponding reward function for (u₂, x₂) is derivable from (u₁, x₁), the Q-function for (u₂, x₂) can be directly computed from the Q-function of (u₁, x₁) without a new iteration (e.g., using a multiplier that represents the relationship between the respective reward functions for (u₁, x₁) and (u₂, x₂)).

For example, r(x, u, y) can be a deterministic reward function that sets the reward for making a transition from a state x of device 130 to a state y as a result of applying a control input u. A policy π can define the probability distribution of the actions for each current state. Control system 112 can apply a control input u to state x using policy π derived from the Q-function. Control system 112 can then observe next state x⁺ and the corresponding reward function r(x,u, x⁺). Based on the observation, control system 112 can update the Q-function values by applying: Q(x,u)←Q(x,u)+aₖ[r(x, u, x⁺)+ymaxuQx+,u−Qx,u. Control system 112 then transitions the current state and control input of device 130 as x←x⁺ and u←u⁺. Control system 112 can continue to update the approximation of the Q-function and compute an efficient policy for device 130.

If {xₖ} is a sample trajectory of a process obtained with the policy π(xₖ). The corresponding control process and rewards can be denoted as {uₖ} and {rₖ}, respectively. Based on the Q-learning algorithm, control system 112 can iteratively learn the Q-function for state-action pair (xₖ, uₖ). Suppose that an invertible map Γ: [symbol] × [symbol] → [symbol] × [symbol] exists that generates new state-action pairs Γ(x, u)=(\hat{x}, û). Control prediction system 110 can construct Γ in such a way that if Γ is applied on all pairs (xₖ, uₖ), the sequence {\hat{x}ₖ} resulted from applying {ûₖ} is also a feasible trajectory for device 130. As a result, control system 112 can simultaneously learn the value of the Q-function both at (xₖ, uₖ) and (\hat{x}ₖ, ûₖ) adding a new update iteration for the Q-function (e.g., Q(\hat{x}ₖ, ûₖ)). In some cases, control system 112 can directly compute Q(\hat{x}ₖ, ûₖ) from Q(x, u) without another iteration.

FIG. 1C illustrates an exemplary reinforcement learning of a control prediction system, in accordance with an embodiment described herein. In this example, a pole 170 is balanced on device 130. Starting from an initial position x₀ and an angle θ₀, control system 112 performs actions {u₀, u₁} aimed at stabilizing the cart-pole at the origin (x₀, θ₀) (i.e., experiment 132). Using the geometric symmetry, if device 130 starts from (−x₀, −θ₀), by mirroring the control inputs from the previous case, control prediction system 110 can determine how the cart-pole can be moved toward the origin (x₀, θ₀). For example, by applying the sequence {−u₀, −u₁}, control prediction system 110 can determine how the cart-pole can be moved toward the origin (x₀, θ₀) (i.e., derivation 134). Control prediction system 110 can determine this symmetry regardless of the parameters (e.g., device 130, masses of pole 170, length of pole 170, etc.). Control system 112 can utilize experiment 132 and derivation 134 to establish a policy 136 that can balance the cart-pole at the origin (x₀, θ₀).

### Symmetry-Based Augmentation

In the example in FIG. 1C, control prediction system 110 utilizes the symmetry of device 130 to augment empirical data obtained from experiment 132. Such augmentation can be used to evaluate the Q-function values at additional state-action pairs. Suppose that the behavior of a physical system or device (e.g., device 130). is described by:

xₖ₊₁=f(xₖ, uₖ; θ) (1)

Here, xₖ ∈ [symbol] ⁿ is a state vector, uₖ ∈ [symbol] ^{m} is a vector of inputs (or actions), and θ is a set of parameters. If the physical properties that govern the behavior of the device are known, control prediction system 110 can use a symmetry map that transform a set of trajectories obtained from the empirical data into other sample trajectories.

Control prediction system 110 can determine Γ: [symbol] ⁿ× [symbol] ^{m}→ [symbol] ⁿ× [symbol] ^{m} for the device. Γ can be a symmetry if Γ is a diffeomorphism and (\hat{x}, û)=Γ(x, u) is a solution of Equation (1). For example, if control system 112 determines solution to Equation (1) as:

xₖ=f(f( . . . f(f(i x₀, u₀), u₁) . . . , uₖ₋₂), uₖ₋₁), (2)

control prediction system 110 can also determine solution to Equation (1) as:

\hat{x}ₖ=f(f( . . . f(f(\hat{x}₀, û₀), û₁) . . . , ûₖ₋₂), ûₖ₋₁). (3)

Suppose that xₖ₊₁=Axₖ+Buₖ describes a linear system with a solution that can be expressed as:

xₖ=A^{k}x₀+Σᵢ₌₀^{k-1}MA^{k-i}Buᵢ. (4)

Control prediction system 110 then can determine a symmetry map that follows the particular format Γ(x, u)=(Mx, Nu)=(\hat{x}, û), where M and N are invertible matrices of appropriate dimensions. Based on the symmetry map, control prediction system 110 can determine that Mxₖ=MA^{k}x₀+Σᵢ₌₀^{k-1}MA^{k-i}Buᵢ and \hat{x}ₖ=MA^{k}M⁻¹\hat{x}₀+Σᵢ₌₀^{k-1}MA^{k-i}BN⁻¹ûᵢ can have the same form as Equation (4) if AM=MA and BN=MB.

The symmetry map Γ can be represented in vector form as Γ(x, u)=[Γₓ(x, u), Γᵤ(x, u)], where \hat{x}=Γₓ(x, u) and û=Γᵤ(x, u). If the input is chosen based on a stationary and state dependent policy, u=π(x), \hat{x} and û can be determined as \hat{x}=Γₓ(x, π(x))=Γ̅ₓ(x) and û=Γᵤ(x, π(x))=Γ̅ᵤ(x)=(Γ̅ᵤ∘Γ̅ₓ⁻¹)(\hat{x}), respectively. The corresponding inverse transformations can be x=Γ̅ₓ⁻¹(\hat{x}) and u=(Σ∘Γ̅ₓ⁻¹)(\hat{x}). Furthermore, the symmetry condition can now be expressed as Γ̅ₓ∘f=f∘Γ̅ₓ.

For a deterministic behavior dictated by Equation (1), the Q-function can become

$$Q ⋆ ( x , u ) = r ( x , u , y ) + γ {max}_{b} Q ⋆ ( y , b ) ,$$

where y=f(x, u). Using the symmetry maps, control system 112 can generate new trajectories based on the empirical data. These new trajectories can be also used to update of the Q-function. Control system 112 can apply the Q-function iteration at state-action pair (x, u) after computing control input u⁺ corresponding to the next state x⁺ obtained by applying control input u. This allows the computation of trajectory based on derived data (\hat{x}⁺, û⁺)=Γ(x⁺, u⁺) using state-action pair (x⁺, u⁺).

The Q-values computed based on both empirical data and derived data by applying a symmetry map can correspond to efficient reward function values. Since (\hat{x}, û) is a state-action pair resulting from applying Γ to state-action pair (x, u) (i.e., (\hat{x}, û)=Γ(x, u)). If the reward function r(\hat{x}, û, ŷ)=ηr(x, u, y) for all (x, u), where y=f(x, u) and ŷ=f(\hat{x}, û). Thus, an efficient reward function value and Q-function can satisfy V*(\hat{x})=ηV*(x) and Q*(\hat{x}, û)=ηQ*(x, u), respectively. In addition, based on u*=π*(x), û*=(Γ̅ᵤ^{*}∘Γ̅ₓ^{*-1})(\hat{x}) can hold, where Γ̅ₓ^{*}(x)=Γₓ(x, π*(x)) and Γ̅ᵤ^{*}(x)=Γᵤ(x, π*(x)).

On the other hand, for a stochastic behavior dictated by Equation (1), randomness can originate from the initial conditions and external conditions can affect the operations of the device. For such a device, control prediction system 110 can consider a map f: [symbol] × [symbol] × [symbol] → [symbol] , where the behavior of the device can be represented by:

Xₖ₊₁=f(Xₖ, Uₖ, Wₖ; θ) (5)

Here, Wₖ can represent the external conditions that can perturb the state transitions. Suppose that {Xₖ, Uₖ, Wₖ} is a solution of Equation (5). The map Γ: [symbol] × [symbol] × [symbol] → [symbol] × [symbol] × [symbol] can represent a strong symmetry of Equation (5) if (\hat{X}ₖ, Ûₖ, Wₖ)=Γ(Xₖ, Uₖ, Wₖ)=(Φ(Xₖ, Uₖ), Wₖ) is a solution of Equation (5), where Φ: [symbol] × [symbol] → [symbol] × [symbol] . The strong symmetry can indicate that the statistical properties of the external conditions remain unchanged.

Suppose that {(Xₖ, Uₖ)}_{k≥0} is a trajectory of Equation (5), where X₀=x₀ and Uₖ is determined based on some policy Uₖ=π(Xₖ). {(\hat{X}ₖ, Ûₖ)}_{k≥0} can be a trajectory obtained by applying a strong symmetry map to empirical data. If a scalar η exists such that R(\hat{X}ₖ, Ûₖ)=ηR(Xₖ, Uₖ) with a probability of one, and that dP(Xₖ₊₁|Xₖ, Uₖ)=dP(\hat{X}ₖ₊₁|\hat{X}ₖ, Ûₖ), for any x₀, an efficient reward function value and Q-function can satisfy V*(\hat{x}₀)=ηV*(x₀) and Q*(\hat{x}₀, û₀)=ηQ*(x₀, u₀), respectively, with u₀=π(x₀).

### Efficient Policy Generation

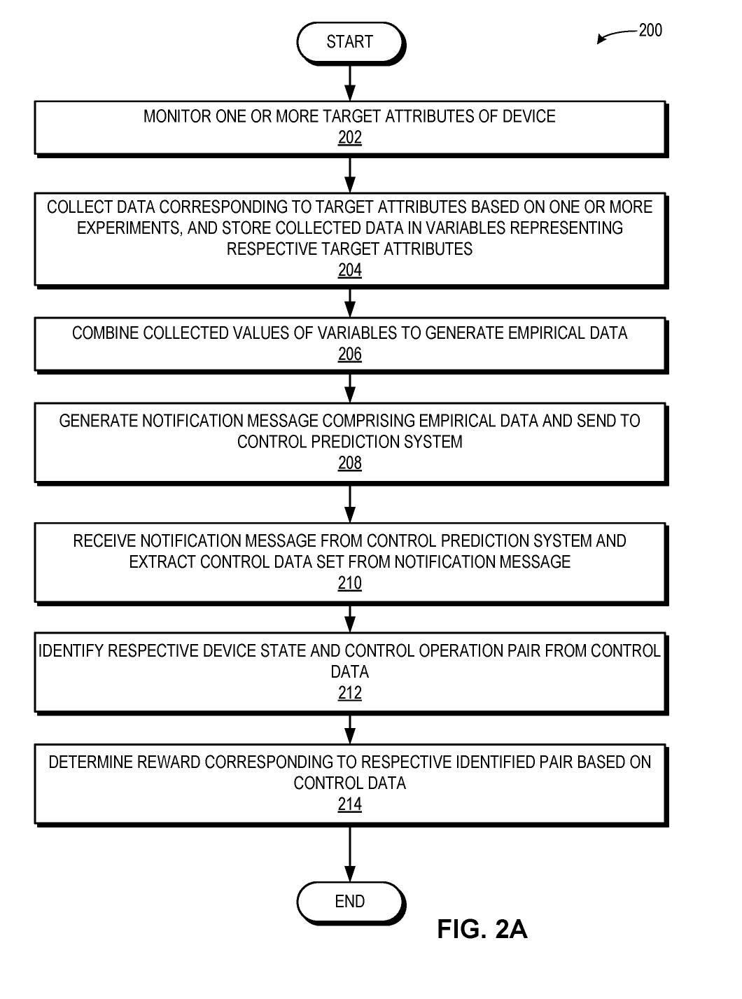

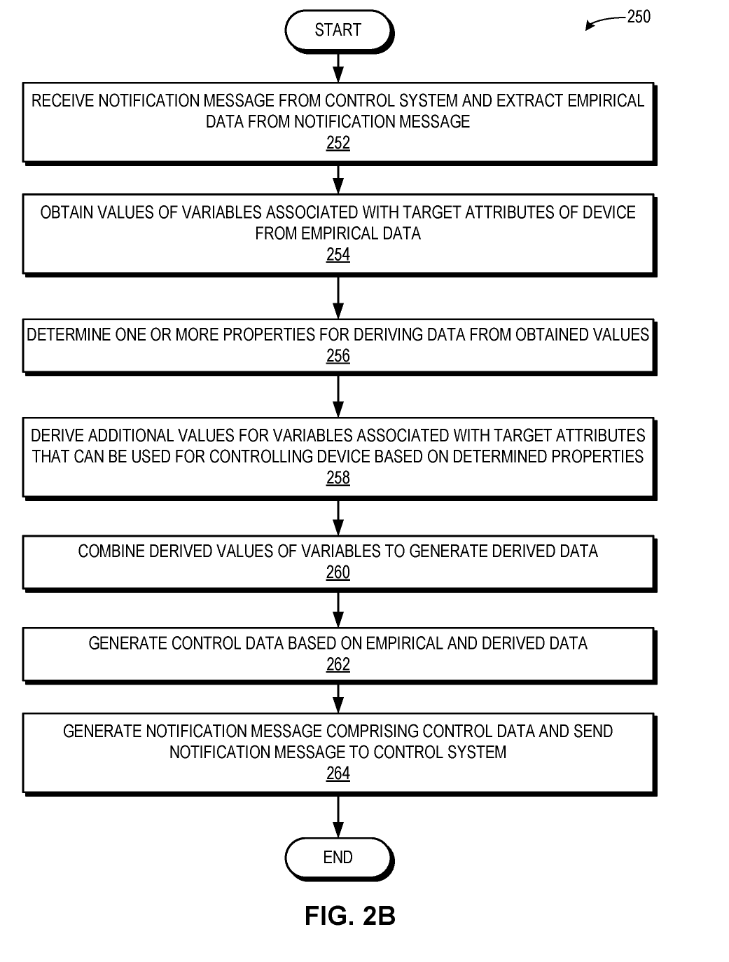

FIG. 2A presents a flowchart 200 illustrating a method of a control system obtaining a control data set for a device and determining corresponding device behavior, in accordance with an embodiment described herein. During operation, the control system monitors one or more target attributes of the device (operation 202). Such target attributes can indicate how the device behaves in an environment. The control system then collects data corresponding to target attributes based on one or more experiments, and stores the collected data in variables representing respective target attributes (operation 204). The control system combines the collected values of variables to generate an empirical data (operation 206).

The control system generates a notification message comprising the empirical data and sends the notification message to a control prediction system (operation 208). Sending a message includes determining an output port for the message based on a destination address of the message and transmitting the message via the output port. The control system then receives a notification message from the control prediction system and extracts the control data from the notification message (operation 210). The control system determines a respective device state and control operation pair from the control data (operation 212) and determines a reward corresponding to a respective identified pair based on the control data (operation 214).

FIG. 2B presents a flowchart 250 illustrating a method of a control prediction system determining a control data set for a device, in accordance with an embodiment described herein. During operation, the control prediction system receives a notification message from a control system and extracts empirical data from the notification message (operation 252). The control prediction system obtains the values of the variables associated with the device from the empirical data (operation 254). The control prediction system then determines one or more properties for deriving data from the obtained values (operation 256). For example, if the obtained values indicate a vehicle's acceleration from left to right, the control prediction system determines the property of symmetry that can be applied to the obtained values.

The control prediction system derives additional values for the variables associated with the target attributes that can be used for controlling the device based on the determined properties (operation 258). For example, the derived values can indicate a vehicle's acceleration from right to left based on the symmetry of the device. The control prediction system combines the derived values of the variables to generate derived data (operation 260) and generates control data based on the empirical and derived data (operation 262). The control prediction system generates a notification message comprising the control data and sends the notification message to the control system (operation 264).

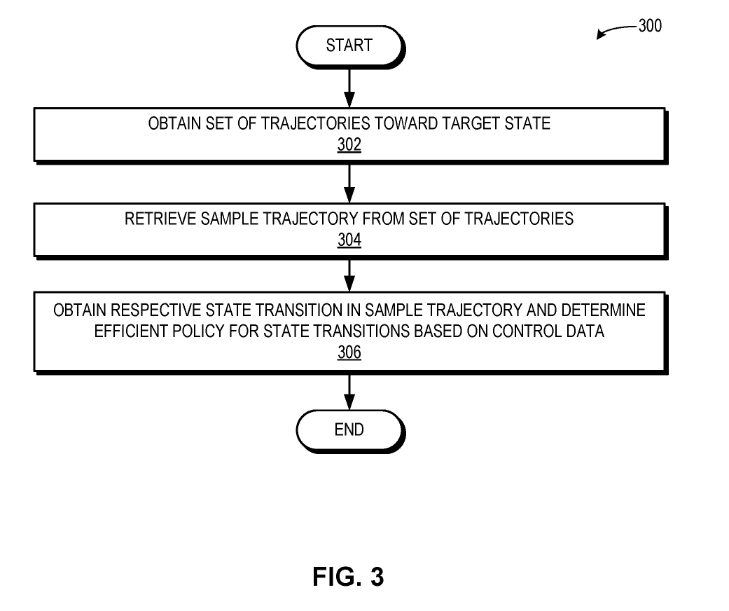

FIG. 3 presents a flowchart 300 illustrating a method of a control system determining an efficient policy for a device, in accordance with an embodiment described herein. During operation, the control system obtains a set of trajectories toward a target state (operation 302). A specific sequence of state transitions can indicate a trajectory for the device. The control system retrieves a sample trajectory from the set of trajectories (operation 304). The control system obtains a respective state transition in the sample trajectory and determines an efficient policy for the state transitions based on the control data (operation 306).

### Efficient Policy Learning

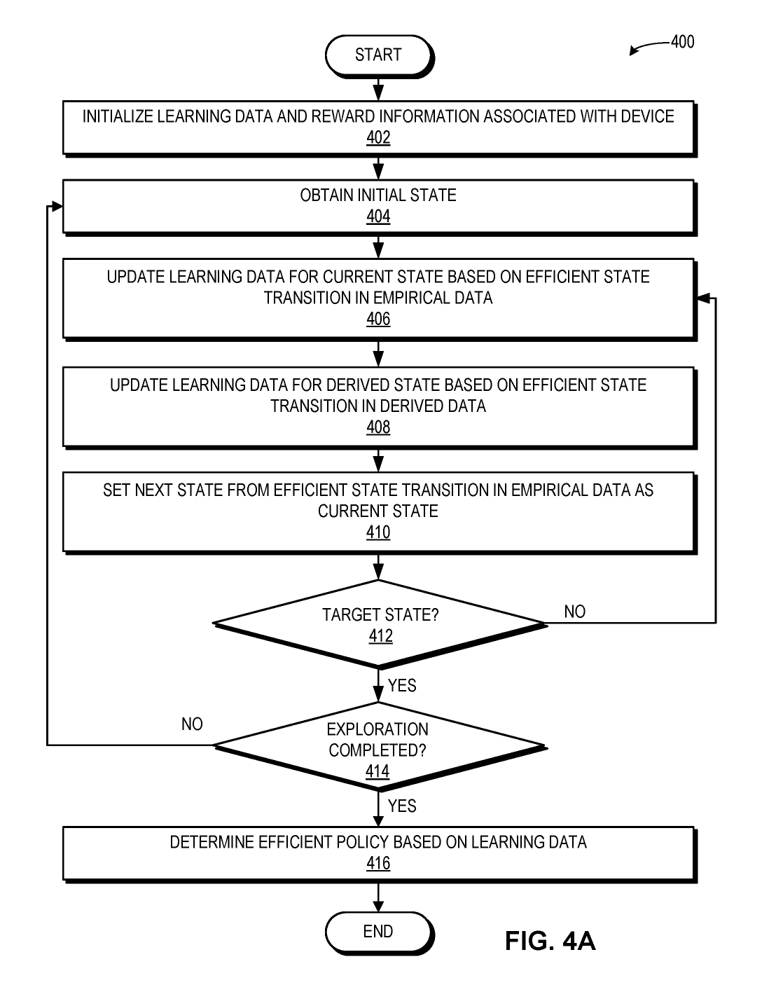

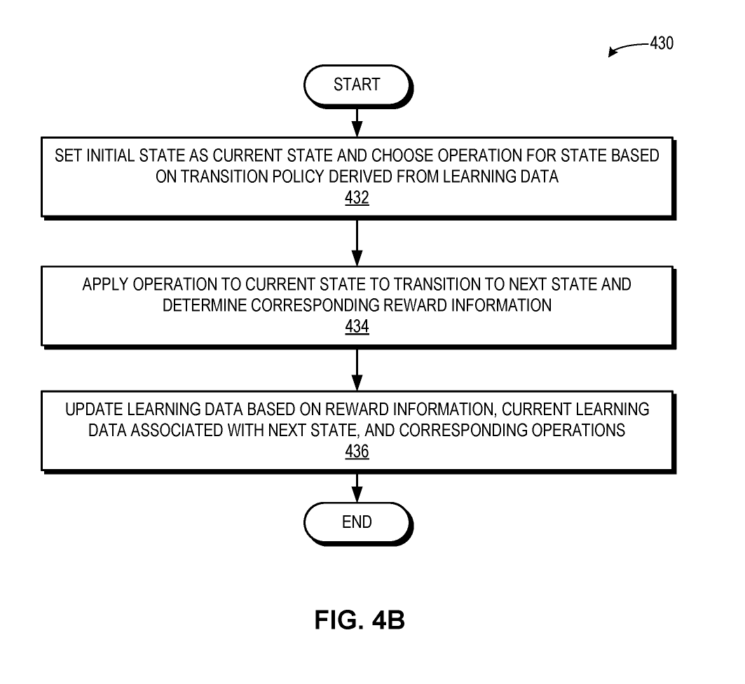

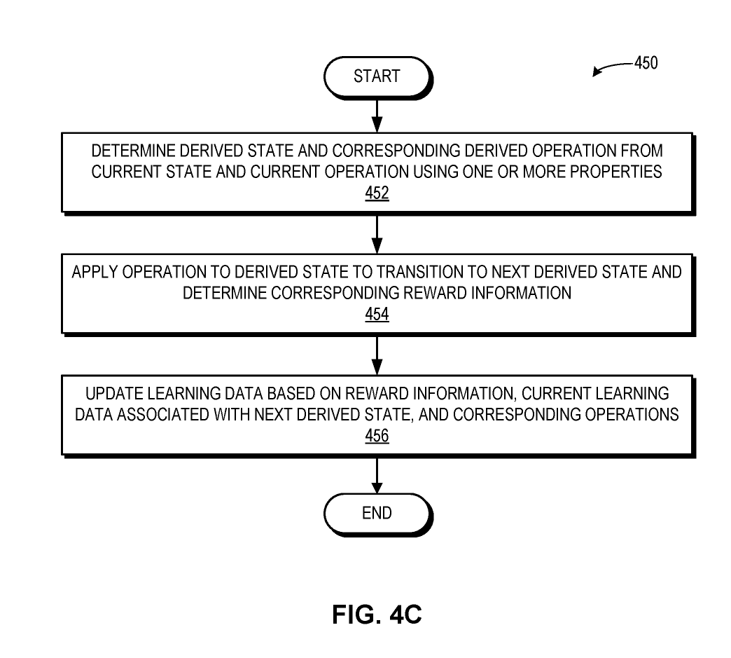

In some embodiments, the control system can use a learning algorithm to determine an efficient policy. FIG. 4A presents a flowchart 400 illustrating a method of a control system learning an efficient policy based on learning data, in accordance with an embodiment described herein. During operation, the control system initializes learning data and reward information associated with the device (operation 402). In some embodiments, the learning algorithm is based on a Q-learning algorithm and the learning data is a Q-function. The control system obtains an initial state (e.g., from user input) (operation 404).

The control system then updates the learning data for the current state based on an efficient state transition in the empirical data (operation 406). In addition, the control system updates the learning data for the current state based on an efficient state transition in the derived data (operation 408). The control system sets a next state from the efficient state transition in the empirical data as the current state (operation 410). The control system then checks whether the target has been reached (operation 412).

If the target state has not been reached, the control system continues to update the learning data for the current state based on an efficient state transition in the empirical data (operation 406). On the other hand, if the target state has been reached, the control system checks whether the exploration is completed (operation 414). If the exploration is not completed, the control system determines another initial state (operation 404). However, if the exploration is completed, the control system determines an efficient policy based on the learning data (operation 416).

FIG. 4B presents a flowchart 430 illustrating a method of a control system updating empirical learning data for learning an efficient policy, in accordance with an embodiment described herein. Flowchart 430 corresponds to operation 406 in FIG. 4A. During operation, the control system sets the initial state as the current state and chooses an operation for the state based on a transition policy derived from the learning data (operation 432). The control system applies the operation to the current state to transition to the next state and determines corresponding reward information (operation 434). The control system then updates the learning data (e.g., the Q-function) based on the reward information, the current learning data associated with the next state, and the corresponding operations (operation 436). These operations can be the operations that allow a state transition from the next state.

FIG. 4C presents a flowchart 450 illustrating a method of a control system updating derived learning data for learning an efficient policy, in accordance with an embodiment described herein. Flowchart 450 corresponds to operation 408 in FIG. 4A. During operation, the control system determines a derived state and corresponding derived operation from the current state and the current operation using one or more properties (e.g., symmetry) (operation 452). The control system applies the operation to the derived state to transition to the next derived state and determines corresponding reward information (operation 454). The control system then updates the learning data based on the reward information, the current learning data associated with the next derived state, and the corresponding operations (operation 456). These operations can be the operations that allow a state transition from the next derived state.

In some embodiments, the system can arbitrarily initialize Q₀(·,·). Until the system reaches a final (or absorbing) state, the system initializes state x and determines a control input u for state x using policy 90 derived from the Q-function. The policy π can define the probability distribution of the actions for each current state. In each step, the system apply input u and observe next state x⁺ and the corresponding reward function r(x, u, x⁺). Here, r(x, u, y) can be a deterministic reward function that sets the reward for making a transition from a state x to a state x⁺ as a result of applying input u. The system then determines a control input u⁺ for state x⁺ using policy π derived from the Q-function.

Based on the observation, the system can update the Q-function values by calculating

$$Q ( x , u ) ← Q ( x , u ) + {α}_{k} [ r ( x , u , {x}^{+} ) + γ {max}_{a} Q ( {x}^{+} , a ) - Q ( x , u ) ] .$$

The system then computes (\hat{x}, û)=Γ(x, u) and (\hat{x}⁺, û⁺)=Γ(x⁺, u⁺), where Γ is a symmetry map. Based on the computation, the system can update the Q-function values by calculating

$$Q ( \hat{x} , \hat{u} ) ← Q ( \hat{x} , \hat{u} ) + {α}_{k} [ r ( \hat{x} , \hat{u} , {\hat{x}}^{+} ) + γ {max}_{a} Q ( {\hat{x}}^{+} , a ) - Q ( \hat{x} , \hat{u} ) ] .$$

The system then transitions the current state and control input by applying x←x⁺ and u←u⁺. The system can continue to update the approximation of the Q-function and compute an efficient policy until the system reaches a final state. The efficient policy can be calculated based on

$${U}_{k}^{*} = arg {max}_{u ∈ 𝒰} Q ⋆ ( {X}_{k} , u ) , ∀ k ,$$

where Uₖ can indicate control actions that can maximize the expected total reward.

In some embodiments, the system can reduce the iteration associated with the calculation of Q(\hat{x}, û). Upon calculating Q(x, u), the system computes (\hat{x}, û)=Γ(x, u). However, instead of calculating (\hat{x}⁺, û⁺)=Γ(x⁺, u⁺), the system can update the Q-function values by calculating Q(\hat{x}, û)=ηQ(x, u). The system then transitions the current state and control input by applying x←x⁺ and u←u⁺. The system can continue to update the approximation of the Q-function and compute an efficient policy until the system reaches a final state.

### Control Operations

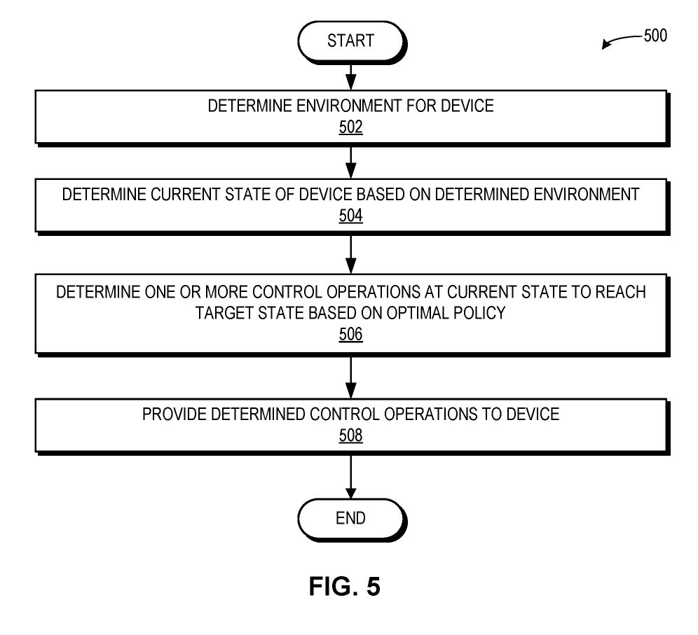

Based on efficient policies, the control system can determine a control operation for a device. FIG. 5 presents a flowchart 500 illustrating a method of a control system determining a control operation for the environment of a device, in accordance with an embodiment described herein. During operation, the control system determines an environment for the device (operation 502) and a current state of the device based on the determined environment (operation 504). The control system determines one or more control operations at the current state of the device to reach the target state based on optimal policy (operation 506). The control system provides the determined control operations to the device (operation 508).

### Exemplary Computer and Communication System

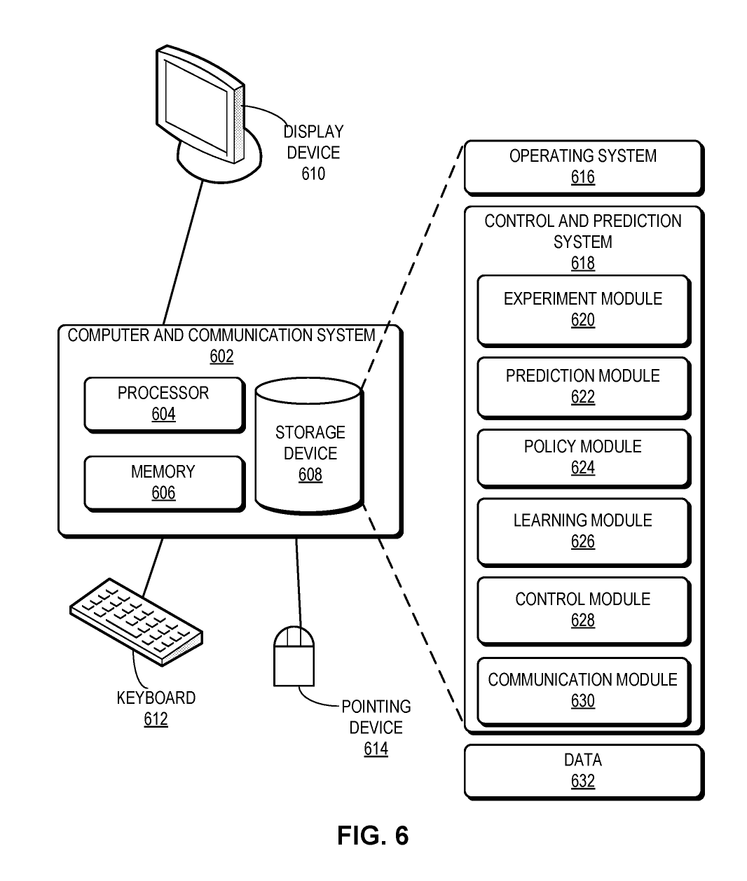

FIG. 6 illustrates an exemplary computer and communication system that facilitates a control and prediction system, in accordance with an embodiment described herein. A computer and communication system 602 includes a processor 604, a memory 606, and a storage device 608. Memory 606 can include a volatile memory (e.g., RAM) that serves as a managed memory, and can be used to store one or more memory pools. Furthermore, computer and communication system 602 can be coupled to a display device 610, a keyboard 612, and a pointing device 614. Storage device 608 can store an operating system 616, a control and prediction system 618, and data 632.

Here, control and prediction system 618 can represent control system 112 and/or control prediction system 110, as described in conjunction with FIG. 1A. Control and prediction system 618 can include instructions, which when executed by computer and communication system 602, can cause computer and communication system 602 to perform the methods and/or processes described in this disclosure.

Control and prediction system 618 includes instructions for generating an instruction for a device to generate empirical data (e.g., based on experiments) (experiment module 620). Control and prediction system 618 further includes instructions for generating derived data from the empirical data based on one or more properties of the device (prediction module 622). Control and prediction system 618 also includes instructions for generating control data from the empirical and derived data (prediction module 622).

Control and prediction system 618 can include instructions for determining an efficient policy across different trajectories of the device (policy module 624). Control and prediction system 618 can also include instructions for performing reinforced learning to learn an efficient policy (learning module 626). In some embodiments, control and prediction system 618 can include instructions for controlling the device based on the efficient policy (control module 628).

Control and prediction system 618 can also include instructions for exchanging information with the device and/or other devices (communication module 630). Data 632 can include any data that is required as input or that is generated as output by the methods and/or processes described in this disclosure. Data 632 can include one or more of: the empirical data, the derived data, the control data, the learning data, the reward information, and policy information.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present disclosure described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating comprehensive control data for a device, the method comprising:
determining, by a computer, one or more properties of the device that can be applied to empirical data of the device, wherein the empirical data is obtained based on experiments performed on the device;
applying the one or more properties to the empirical data to obtain derived data;
learning an efficient policy for the device based on both empirical and derived data, wherein the efficient policy indicates one or more operations of the device that can reach a target state from an initial state of the device; and
determining an operation for the device based on the efficient policy.

2. The method of claim 1, wherein applying the one or more properties to the empirical data comprises:
determining a first state and a corresponding first operation from the empirical data; and
deriving a second state and a corresponding second operation by calculating the one or more properties for the first state and the first operation.

3. The method of claim 1, wherein learning the efficient policy for the device comprises:
determining a first state transition in the derived data that maximizes a corresponding first reward function indicating a benefit of the first state transition for the device, wherein the first state transition is determined based on a second state transition in the empirical data that maximizes a corresponding second reward function.

4. The method of claim 3, wherein learning the efficient policy for the device further comprises updating a learning function for the first and second state transitions.

5. The method of claim 5, wherein updating the learning function for the first state transition comprises computing the learning function based on a relationship between the first and second reward functions.

6. The method of claim 1, wherein the one or more properties include a symmetry of operations of the device.

7. The method of claim 1, wherein determining the operation for the device further comprises:
determining a current environment for the device;
identifying a state representing the current environment; and
determining the operation corresponding to the state based on the efficient policy.

8. The method of claim 1, further comprising:
obtaining a set of trajectories for the device, wherein a respective trajectory indicates a sequence of state transitions for the device; and
determining the efficient policy based on the entire set of trajectories.

9. A non-transitory computer-readable storage medium storing instructions that when executed by a computer cause the computer to perform a method for facilitating comprehensive control data for a device, the method comprising:
determining one or more properties of the device that can be applied to empirical data of the device, wherein the empirical data is obtained based on experiments performed on the device;
applying the one or more properties to the empirical data to obtain derived data;
learning an efficient policy for the device based on both empirical and derived data, wherein the efficient policy indicates one or more operations of the device that can reach a target state from an initial state of the device; and
determining an operation for the device based on the efficient policy.

10. The computer-readable storage medium of claim 9, wherein applying the one or more properties to the empirical data comprises:
determining a first state and a corresponding first operation from the empirical data; and
deriving a second state and a corresponding second operation by calculating the one or more properties for the first state and the first operation.

11. The computer-readable storage medium of claim 9, wherein learning the efficient policy for the device comprises:
determining a first state transition in the derived data that maximizes a corresponding first reward function indicating a benefit of the first state transition for the device, wherein the first state transition is determined based on a second state transition in the empirical data that maximizes a corresponding second reward function.

12. The computer-readable storage medium of claim 11, wherein learning the efficient policy for the device further comprises updating a learning function for the first and second state transitions.

13. The computer-readable storage medium of claim 12, wherein updating the learning function for the first state transition comprises computing the learning function based on a relationship between the first and second reward functions.

14. The computer-readable storage medium of claim 9, wherein the one or more properties include symmetry of operations of the device.

15. The computer-readable storage medium of claim 9, wherein determining the operation for the device further comprises:
determining a current environment for the device;
identifying a state representing the current environment; and
determining the operation corresponding to the state based on the efficient policy.

16. The computer-readable storage medium of claim 9, wherein the method further comprises:
obtaining a set of trajectories for the device, wherein a respective trajectory indicates a sequence of state transitions for the device; and
determining the efficient policy based on the entire set of trajectories.

17. A computer system; comprising:
a storage device;
a processor;
a non-transitory computer-readable storage medium storing instructions, which when executed by the processor causes the processor to perform a method for facilitating comprehensive control data for a device, the method comprising:
determining one or more properties of the device that can be applied to empirical data of the device, wherein the empirical data is obtained based on experiments performed on the device;
applying the one or more properties to the empirical data to obtain derived data;
learning an efficient policy for the device based on both empirical and derived data, wherein the efficient policy indicates one or more operations of the device that can reach a target state from an initial state of the device; and
determining an operation for the device based on the efficient policy.

18. The computer system of claim 17, wherein applying the one or more properties to the empirical data comprises:
determining a first state and a corresponding first operation from the empirical data; and
deriving a second state and a corresponding second operation by calculating the one or more properties for the first state and the first operation.

19. The computer system of claim 17, wherein learning the efficient policy for the device comprises:
determining a first state transition in the derived data that maximizes a corresponding first reward function indicating a benefit of the first state transition for the device, wherein the first state transition is determined based on a second state transition in the empirical data that maximizes a corresponding second reward function.

20. The computer system of claim 17, wherein determining the operation for the device further comprises:
determining a current environment for the device;
identifying a state representing the current environment; and
determining the operation corresponding to the state based on the efficient policy.
